(19) United States
(12) Patent Application Publication
(10) Pub. No.: US 2013/0103647 A1
(43) Pub. Date: Apr. 25, 2013

(54) SYSTEM AND METHOD FOR ARCHIVING AND RETRIEVING FILES

(71) Applicants: Kinson Kin Sang HO, Waterloo (CA); William Eric WALLACE, Waterloo (CA); Steven Joseph KROETSCH, Kitchener (CA)

(72) Inventors: Kinson Kin Sang HO, Waterloo (CA); William Eric WALLACE, Waterloo (CA); Steven Joseph KROETSCH, Kitchener (CA)

(73) Assignee: AGFA HEALTHCARE INC., Toronto (CA)

(21) Appl. No.: 13/280,913

(22) Filed: Oct. 25, 2011

(51) Int. Cl. G06F 17/30; G06F 7/00

(52) U.S. Cl. 707/661; 707/705; 707/E17.019

(57) ABSTRACT

A system and method for retrieving objects stored on a storage medium, the method comprises receiving a request from a first client for a first object; populating a queue with the request for the first object; retrieving the first object from the storage medium; and sending the object to the first client.

### FIELD

The present disclosure relates generally to systems and methods for retrieving objects stored on a storage medium. More particularly, the present disclosure relates to systems and methods for efficiently retrieving objects requested by a client.

### BACKGROUND

Client computing devices are often used to interact with data that, at least initially, is stored on a storage medium that is not directly coupled to the client computing device. Such arrangements are not restricted to any particular field or industry.

An example of such an arrangement includes client computing devices that are used to view medical images. The medical images are generally stored on a storage medium that is not directly coupled to the client computing device. For example, the client computing device and download the images from the storage medium through one or more networks.

### SUMMARY

In a first aspect, the present disclosure provides a method of retrieving objects stored on a storage medium. In various embodiments, the request is generated by a client computing device and is received at a server. In some embodiments, the storage medium is coupled directly to the server and in other embodiments the storage medium is coupled indirectly (e.g. through one or more networks) to the server.

The method includes receiving a request from a first client for a first object. As used herein the term “includes” is used to denote an open ended inclusion in that other items may also be included besides those that are specifically listed.

The method further includes populating a queue with the request for the first object, retrieving the first object from the storage medium; and sending the object to the first client.

In various embodiments, the first object can be an image file, a set of images, and a set of image files. In some embodiments, the set of images comprises a study, such as, for example, a study generated by a modality.

In some embodiments, the request comprises an unordered request for a plurality of images of the study and wherein each image of the study is provided to the first client as it is retrieved.

In various embodiments, the method further includes storing the retrieved object in a cache.

In some embodiments, the method further includes archiving aspects. In various embodiments where the object belongs to a set of objects, the method further comprises: receiving the set of objects from an object source, selecting storage parameters for the set of objects, the storage parameters being selected to optimize retrieval time of the objects, the storage parameters comprising a maximum size of an archive file and a number of objects per archive file; and storing the objects on the storage medium according to the determined storage parameters.

In some embodiments, the objects comprise images and the object source comprises a modality.

In some embodiments, the method further comprises: prior to receiving a request for a second object, retrieving the second object from the storage medium; and storing the second object in a cache.

In various embodiments, the method further comprises: receiving a request for the second object from the first client; and providing the second object to the first client.

In some embodiments, populating the queue with the request comprises writing a future to the queue, the future corresponding to the requested object.

In some embodiments, the method further comprises: writing the first object to a cache; and notifying the future that the first object has been retrieved.

In some embodiments, the method further comprises: blocking an attempt to access the first object from the future if the attempt is made prior to notifying the future that the first object has been retrieved.

In some embodiments, the method further comprises: subsequent to the first object being written to the future on the queue, unblocking the attempt to access the first object.

In some embodiments, the method further comprises: receiving a second request for the first object from a second client; populating the queue with the second request for the first object; determining that the queue contains a first request for the first object; and providing the requested object to the second client from the cache.

In further aspect, the present disclosure provides a method of archiving object on a storage medium for efficient retrieval. In some embodiments, the method of archiving objects includes receiving the set of objects from an object source; selecting storage parameters for the set of objects, the storage parameters being selected to optimize retrieval time of the objects, the storage parameters comprising a maximum size of an archive file and a number of objects per archive file; and storing the objects on the storage medium according to the determined storage parameters.

In some embodiments, the objects comprise images and the object source comprises a modality.

In a further embodiment, there is provided a non-transitory machine-readable memory storing statements and instructions for execution by a processor to perform a method of: receiving a request from a first client for a first object; populating a queue with the request for the first object; retrieving the first object from a storage medium; and sending the object to the first client.

In further aspect, the present disclosure provides a system for retrieving files.

In various embodiments, the system comprising: a queue; a thread pool; a cache; and a processor, the processor configured to: receive a request from a first client for a first object; populate the queue with the request for the first object; retrieve the first object from a storage medium; and send the object to the first client.

In various embodiments, the first object can be an image file, a set of images, and a set of image files. In some embodiments, the set of images comprises a study, such as, for example, a study generated by a modality.

In some embodiments, the request comprises an unordered request for a plurality of images of the study and wherein each image of the study is provided to the first client as it is retrieved.

In various embodiments, the processor is further configured to store the retrieved object in the cache.

In some embodiments, the system also archives files. In various embodiments, the object belongs to a set of objects and the processor being further configured to: receive the set of objects from an object source; select storage parameters for the set of objects, the storage parameters being selected to optimize retrieval time of the objects, the storage parameters comprising a maximum size of an archive file and a number of objects per archive file; and store the objects on the storage medium according to the determined storage parameters.

In some embodiments, the objects comprise images and the object source comprises a modality.

In some embodiments, the processor is further configured to: prior to receiving a request for a second object, retrieve the second object from the storage medium; and store the second object in a cache.

In some embodiments, the processor is further configured to: receive a request for the second object from the first client; and send the second object to the first client.

In some embodiments, the processor is further configured to populate the queue with the request by writing a future to the queue, the future corresponding to the requested object.

In some embodiments, the processor is further configured to: write the first object to a cache; and notify the future that the first object has been retrieved.

In some embodiments, the processor is further configured to: block an attempt to access the first object from the future if the attempt is made prior to notifying the future that the first object has been retrieved.

In some embodiments, the processor is further configured to: subsequent to the first object being written to the future on the queue, unblocking the attempt to access the first object.

In some embodiments, the processor is further configured to: receive a second request for the first object from a second client; populate the queue with the second request for the first object; determine that the queue contains a first request for the first object; and provide the requested object to the second client from the cache.

In further aspect, the present disclosure provides a system for archiving files for efficient retrieval. In some embodiments, the system comprises a processor configured to: receive the set of objects from an object source; select storage parameters for the set of objects, the storage parameters being selected to optimize retrieval time of the objects, the storage parameters comprising a maximum size of an archive file and a number of objects per archive file; and store the objects on the storage medium according to the determined storage parameters.

In some embodiments, the objects comprise images and the object source comprises a modality.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a the block diagram of an image archiver retriever system according to various environments;

FIG. 2 is a flowchart illustrating a process by which the archiver retriever system of FIG. 1 performs asynchronous streaming retrieval of data, according to various embodiments;

FIG. 3 is a flowchart illustrating a process by which the archiver retriever system of FIG. 1 performs ordered retrieval of data, according to various embodiments;

FIG. 4 is a flowchart illustrating a process by which the archiver retriever system of FIG. 1 performs unordered retrieval of data, according to various embodiments; and

FIG. 5 is a flowchart illustrating a process by which the archiver retriever system of FIG. 1 responds to redundant requests for data, according to various embodiments.

### DETAILED DESCRIPTION

The embodiments disclosed herein generally relate to systems and methods for archiving files and efficiently retrieving the files when requests for the files are received from a client.

Some embodiments disclosed herein relate to image archiver and retriever systems. Some embodiments disclosed herein relate to medical image archiver and retriever systems.

Medical images are often generated by modalities during the patient examination. These images are then stored and later viewed by a user, such as for example a radiologist, on a computer. When a modality is used to perform the patient examination, the modality generally generates a set of images, which is referred to as a “study”. Each study response to a given patient and includes a number of images. Each study can be subdivided into a series of images. Accordingly, in some implementations, the medical images are generally organized in a hierarchy that corresponds to: patient-study-series-image.

The studies generated by modalities today are, in general, larger than the studies that were generated in the past. It seems to be a trend that studies will continue to grow in size. The studies are larger in the sense that each study has a greater number of images and also that each image includes a greater amount of data. Accordingly, a large amount of data storage space is required to store the studies. In addition, it is generally impractical for a user to store on his or her personal computer all the images that he or she would ever want to view given that such an arrangement would involve each user in maintaining his or her own data set.

Accordingly, in known systems, all of the images of a given study may be stored in an image database. The image database may be off-site with respect to the user desiring to view the image data, such as for example at a server. In addition, all of the images of a system are often stored in a single file. This has the benefit of minimizing disk I/O operations, for better performance and file management given that there is only a single file to be moved instead of hundreds when moving a study. In addition, the study is often stored in a compressed format, which allows for saving storage space.

A user will generally utilize a client to retrieve image data from the image database through for example an image server. The user would generally like to see the requested images without a significant delay. However, in known systems there is generally a noticeable delay associated with retrieving images given that the images are generally retrieved from an off-site storage device through a network. Accordingly, the off-site storage scheme allows for a large amount of storage space; however, the storage is generally noticeably slow. Accordingly, from the perspective of the user, the storage scheme used by known systems appears infinite but slow. Accordingly, in known systems, when it is known ahead of time that a given study will be viewed, study may be downloaded in advance. For example, if it is known that the patient has an appointment on a given day with a health professional, a study associated with that patient may be downloaded to the health professional's computer on the night preceding the patient's appointment. However, it is not always possible to predict which studies will be viewed by a user. In addition, even for those cases where the images are downloaded in advance, the images are often downloaded in an inefficient manner which ties up network resources to a high degree.

Accordingly, it is desirable to create the perception of infinite and fast storage. Some embodiments disclosed herein address this need by providing systems and methods for efficiently providing image data from a storage medium to a client.

It is also desirable that image data be provided to a user regardless of whether the client issues ordered or unordered requests for the image data. Some embodiments disclosed herein address this need by providing systems and methods for efficiently providing image data from a storage medium to a client for both ordered and unordered requests.

Various embodiments of archiver retriever system 10 address these needs through:

storing images in a manner that optimizes retrieval time;

supporting asynchronous streaming retrieval of images;

supporting ordered and unordered retrieval of images; and

supporting redundant requests in an efficient manner.

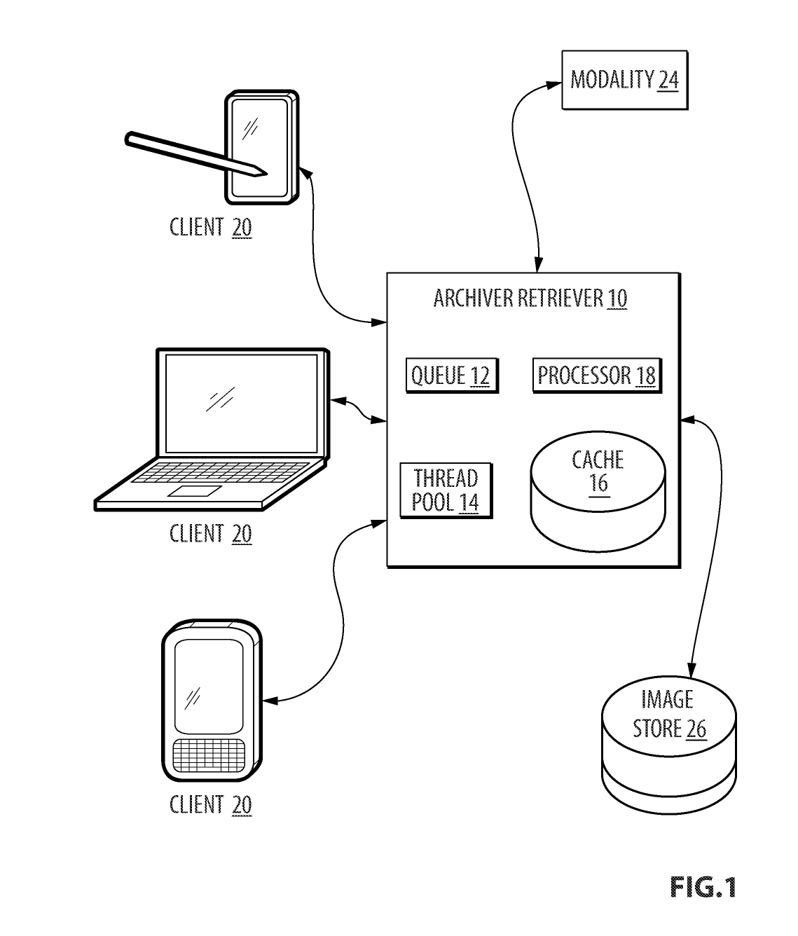

Reference is first made to FIG. 1, which is a block diagram illustrating the components of an archiver retriever system 10 in accordance with various example embodiments. Archiver retriever system 10 includes a blocking queue 12, a thread pool 14, a cache 16, and a processor 18. In various embodiments, cache 16 comprises a physical memory device. One or more clients 20 can be coupled to archiver retriever system 10 in any appropriate manner. For example, a given client 20 can be coupled to archiver retriever system 10 through one or more networks, which may include, for example, the internet or an intranet. Alternatively, client 20 can be coupled to archiver retriever system 10 through a direct connection. Client 20 can be any appropriate computing device, including but not limited to a desktop computer, a laptop computer, a tablet computer, and a smartphone.

Archiver retriever system 10 is coupled, through in any suitable manner including but not limited to a network as described above, to modality 24, which can be any appropriate modality including, but not limited to, any suitable image data generating device (e.g. computed radiography (CR) systems, computed tomography (CT) scanners, magnetic resonance imaging (MRI) systems, positron emission tomography (PET), ultrasound systems, etc.) utilized to generate image data that corresponds to patient medical examinations. Archiver retriever system 10 receives image data from modality 24 and stores it in image store 26. The method by which archiver retriever system 10 stores the images in image store 26 will be described in greater detail below. Archiver retriever system 10 is coupled to image store 26 in any appropriate manner including a network as described above.

Image store 26 can comprise any appropriate storage medium. In some embodiments, image store 26 comprises a physical non-transitory storage medium. In various embodiments, image store 26 can include, but is not limited to, one or more, hard disk drives, flash memory devices, magnetic tape storage devices, optical storage devices, or a combination thereof.

It should be understood that although embodiments related to medical image archiving and retrieval are discussed in detail, other embodiments can relate to archiving and retrieving any appropriate files.

Data Archiving

As explained above, archiver retriever system 10 receives image data from modality 24. For example, modality 24 may be used to perform a study on a patient and the resulting image data is sent to archiver retriever system 10 from modality 24.

Upon receiving the image data, archiver retriever system 10 determines a manner of storing the image data that optimizes the retrieval time of the image data. In some embodiments, this is achieved by determining a number of storage parameters. In various embodiments, the set of images that make up a study are divided into a number of subsets that are each stored in a number of archive files. Each archive file stores one or more images of the study. In various embodiments, the storage parameters can include one or more of, but are not limited to, the maximum size of an archive file, the number of archive files used, and the number of objects per archive file. In some embodiments, the size of the archive file refers to the size as measured in bytes.

In various embodiments, the number of maximum size of an archive file and the number of images in a given archive file are selected to optimize retrieval time. In various embodiments, these two parameters are selected to indirectly control the number of archive files used. In some embodiments, the number of archive files that are used can be controlled directly. In various embodiments, the storage parameters can be dynamically adjusted to optimize retrieval time.

As mentioned above, in known systems, all of the images of a study are generally stored in a single archive file. By storing all the images in a single file the input/output (I/O) time for retrieving the images of the study is generally reduced as compared to the situation where each image is stored as a separate file. For example, by utilizing only a single file, only one disk seek operation, one file open operation, and one file close operation is required to retrieve the image data. However, a given user may need or want to see, at least initially, only certain images of the study and not the entire study. If one of these desired images happens to be the last image in the archive file, then the system would have to read through each of the images in the system before reaching one of the initially desired images. This can introduce a significant delay from the perspective of the user because if one of the desired images is the last image in the study, he or she would need wait for the entire study to be loaded before that image.

An alternative is to store the images in multiple archive files. For example, if there are 1000 images in the study and two archive files are used, then each archive file would have approximately 500 images if images are evenly distributed between the two archive files. Accordingly, if the archive files are processed in parallel, in the worst case scenario, if a desired image is the last image read, it will be the 500^{th} image read. This is in contrast to the situation where a single archive file is used and in the worst case, the image could be the 1000^{th} image read. Accordingly, distributing the images of the study among several archive files can improve the average case scenario, and in particular, minimize the worst-case scenario for retrieving a particular image file. In the extreme, each image as could be stored as a separate file. However, depending on the system set up in the characteristics of image store 26, the use of a greater number of archive files can potentially result in an increased total I/O time. For example, if a number of the archive files are stored on the same physical device and may not be possible to process each of the archive files in parallel and some of them may need to be processed in series, which will increase the I/O time. Moreover, even in cases where there are multiple platters on a disk drive and the disk drive supports parallel read when the files are stored in different platters, storing multiple files can still increase the number of I/O since there are more file open, seek and close operations.

In some embodiments, archiver retriever system 10 balances the benefits of having (1) a small number of archive files, where each archive file contains a large portion of the total number of images in the study, and (2) a large number of archive files, where each archive file contains relatively few image files. The benefits of (1) can include lower I/O time. The benefits of (2) can include improve average case and minimizing the worst case retrieval time of any particular individual image in the case where multiple threads are used to retrieve images from multiple archive files in parallel.

The actual I/O time depends on the characteristics (e.g. physical or logical) of the system used to store and retrieve the image data. For example, the physical characteristics of the storage device (or storage devices) used to store the image can impact the I/O time. For example, a mechanical storage device may introduce greater delay than a solid-state storage device.

In addition, the logical arrangement of the system used to store the image data can also impact the I/O time. As another example, if the images are stored in a cloud environment, this may impact the delay differently than if the images were stored in a non-cloud environment as it may involve the use of a greater number of operations to retrieve the image data. Accordingly, in some arrangements, each call for image data could be associated with a certain set of procedures with a particular delay and therefore, the greater the number of calls for data, the greater the potential delay associated with retrieving the images.

As another example, if a server is used to interface with the storage device, then the characteristics of the server could also impact I/O time. File server may impact the I/O time from both logical and physical perspective. For example, the use of one or more servers impacts total number of intervening devices between client 20 and image store 26, which can increase delay times and each server may introduce delays that are particular to the server itself.

Accordingly, in various embodiments, archiver retriever system 10 determines an optimal storage arrangement for the images of the study based on various criteria, including, but not limited, to those described above, for optimizing the retrieval time. In various embodiments, the optimal storage arrangement can involve storing the images in a number of archive files, where the number of archive files and the number of image files per archive file are selected to optimize retrieval time. In various embodiments, the images are evenly distributed throughout the number of archive files. In other embodiments, the images are not evenly distributed between the archive files and each archive file can have a different number of image files.

In various embodiments, the storage arrangement is dynamically adjustable. For example, in various embodiments, archiver retriever system 10 implements different storage arrangements for the image files when characteristics of the system change. This can occur, for example, when new storage devices with different characteristics are added to image store 26 or old storage devices in image store 26 are replaced by new ones.

Asynchronous and Streaming Retrieve

In various embodiments, archiver retriever system 10 supports an asynchronous streaming retrieval of images to client 20 in response to a request from client 20 for image data. The term asynchronous, as used herein, refers to the aspect that, in various embodiments, images are retrieved from image store 26 in parallel with other operations that are performed in order to respond to a request from client 20 for image data. In other words, in various embodiments, archiver retriever system 10 breaks up each request into multiple tasks, at least some of which may be conducted in parallel. For example, in some embodiments multiple threads from thread pool 14 are used to complete the operations required by a request from client 20.

As indicated above, in order to fulfill the request, archiver retriever system 10 may need to perform a number of tasks. One example task is retrieving the image data. Another example task is updating the image data. The image data may need to be updated in situations where the image data was initially archived and subsequently further information became available. This may occur in situations, for example, where patient examination is conducted on an emergency basis prior to obtaining all the patient information. The image data may be archived before the patient information is received and updated information may be stored separately. Accordingly, in some embodiments 1 threat from thread pool 14 is used to retrieve the image data while a second threat from thread pool 14 could be used to update image information.

The term streaming, as used herein, indicates that, in various embodiments, archiver retriever system 10 returns a requested image to client 20 as soon that image becomes available. For example, client 20 may send a plurality of requests for images or a it may send a single request for multiple images. In various embodiments, the term “send” as used herein is equivalent to the term “transmit”. For example, a client sending a request can correspond to a client transmitting a request over, for example, a network. In some embodiments, as archiver retriever system 10 retrieves the requested images from image store 26, the images are downloaded individually and therefore become available at different times. In some embodiments, archiver retriever system 10 forwards to client 20 the images that have been requested by client 20 as they become available. In other words, in some embodiments, archiver retriever 10 does not retrieve all the requested images prior to forwarding any images to client 20. In some environments, archiver retriever 10 forwards each image to client 20 individually. In other embodiments, archiver retriever 10 forwards groups of images to client 20.

In some embodiments, the images are forwarded almost immediately as they become available. In other embodiments, the images may not be forwarded ritually immediately; however, the images are forwarded individually and therefore, archiver retriever system 10 does not retrieve all of the requested images prior to sending any images to client 20. This is in contrast to known systems where the entire study is downloaded before any images are provided to client 20.

Asynchronous Streaming Retrieval

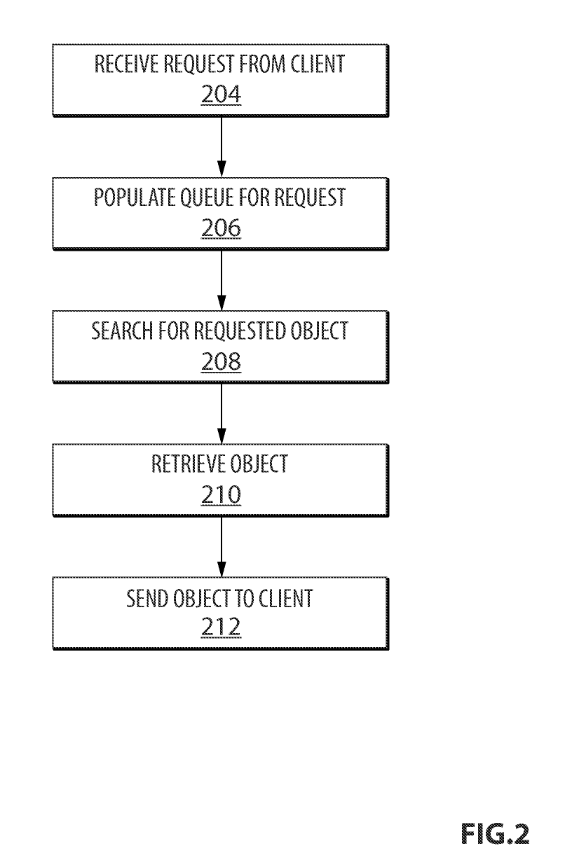

Reference is now made to FIG. 2, which illustrates a flowchart diagram of the process by which archiver retriever system 10 performs asynchronous streaming access of image data, according to various embodiments.

At 204, archiver retriever 10 receives a request for an object from client 20. In various embodiments, the requested object can be any appropriate object. For example, in some embodiments relating to medical imaging, an object can be, but is not limited to, a DICOM object, a study, or an individual image. In other embodiments, the object can be any appropriate object or file stored on a storage medium.

At 206, archiver retriever 10 populates queue 12 with the request. In some embodiments, archiver retriever 10 populates queue 12 by writing a “future” to queue 12 for the requested object. As those skilled in the art will understand, a future can be thought of as a “container” for the requested object.

At 208, archiver retriever 10 searches for the requested object in image store 26. In some embodiments, this involves the use of a thread from thread pool 14 to search for the requested object in an image store 26.

At 210, archiver retriever 10 retrieves the requested object from image store 26. In various embodiments, the retrieved object is placed in cache 16.

In parallel with one or more of 206, 208 and 210, archiver retriever 10 may be performing other tasks, such as for example, retrieving other information to update the retrieved object.

At 212, archiver retriever 10 sends the requested object to client 20. In some embodiments, this involves writing the requested object to network socket.

It should be understood that the term “streaming” as used herein is not the same as the term “streaming” used in the context of streaming video files online. As disclosed herein, various embodiments of archiver retriever 10 support a synchronous streaming of any image files of a study in any order.

Video streaming relates to a single video stream that is encoded in a single file. In contrast, various embodiments of archiver retriever 10 supports streaming a plurality of images where the images can be stored in one or more files.

In addition, although video streaming may allow one to view particular scenes, it does not allow one to view individual images in an arbitrary order. In contrast, various embodiments of archiver retriever 10 supports streaming of medical images in an arbitrary order. Specifically, client 20 can request images in an arbitrary order.

An example of where client 20 may request images in an arbitrary order is when a user, such as a radiologist, uses client 20 to perform a stack view, where the user “scrolls” through the stack at varying levels of “detail”. First, archiver retriever 10 allows the user to scroll through the stack of images by supporting arbitrary order to requests for images from the study. For example, client 20 can be used to request every nth image of the study in a particular “direction”. Furthermore, archiver retriever 10 supports requests from client 20 that allow the user to scroll back and forth through the stack in any direction with varying levels of detail by allowing the value n to vary. For example, each pass through the stack can have a different value of n. For example, the first task could be every tenth image on the second pass could be every fifth image and so forth. Alternatively, n can vary in a single pass. Alternatively, in a given pass through the stomach spacing between each image can be arbitrarily selected as can the direction such that a passed need not linearly progress from one and the study to the other end of the study.

Ordered and Unordered Retrieval

In various embodiments, archiver retriever 10 supports both ordered and unordered retrieval of objects.

Ordered Retrieval

In various embodiments, archiver retriever 10 supports ordered retrieval of objects. In some embodiments, ordered requests may be made for objects. For example, in embodiments related to medical imaging, a user may request particular images of a study to be viewed prior to viewing the rest of the images of the study. For example, a radiologist may wish to see certain key images of the study and upon viewing those images determine which other images of the study to view. Accordingly, in such a situation client 20 may first send several requests for the key images and then send one or more requests corresponding to the rest of the study. In various embodiments, archiver retriever 10 services multiple requests in the order that the requests were made such that the requested key images are retrieved and provided to client 20 first and then the images that make up the rest of the study are provided to client 20. Accordingly, in various embodiments, archiver retriever 10 does not download the entire study before providing the requested key images to client 20.

Accordingly, in various embodiments, archiver retriever 10 provides the key images to client 20 while continuing to retrieve the rest of the images of the study.

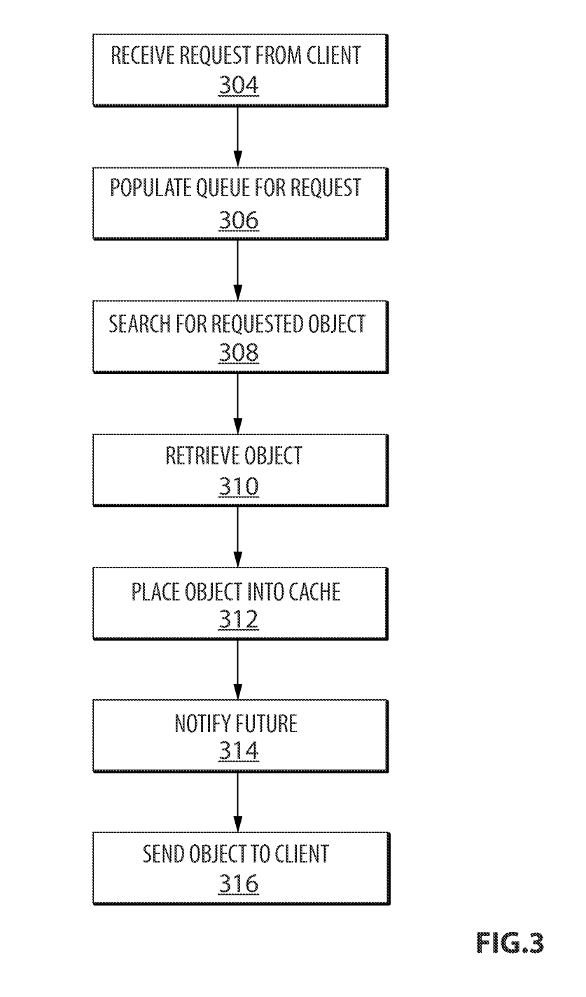

Reference is now made to FIG. 3, which illustrates a flowchart diagram of the process by which archiver retriever system 10 responds to ordered requests for objects from client 20.

At 304, archiver retriever 10 receives an ordered request for an object, or an ordered request for a plurality of object, or a plurality of ordered requests for a plurality of objects.

In some embodiments, archiver retriever 10 determines if a requested object is already stored in cache 16. If the requested object is already present in cache 16, then in some embodiments archiver retriever 10 does not execute 306 to 314 and executes 316 after receiving the request and determining that the requested object is already stored in cache 16.

At 306, archiver retriever 10 populates queue 12 for each request in the order that the requests are received. In some embodiments, each request may have an associated priority and the requests may be populated in queue 12 in order of priority rather than the order in which they were received. As mentioned above, in some embodiments this involves writing a future for each requested object to queue 12, wherein each future corresponds to a requested object.

In some such embodiments, this process, for example at 306 described above, involves a determination of whether the requested image has already been retrieved. As described below that, 312 archiver retriever 10 may retrieve an image from image store 26 even before a request has been sent by client 20 for that image. If the requested image has already been retrieved by archiver retriever 10, then 308, 310, 312 are not executed. In some other embodiments, the retrieved but not yet requested objects are placed in cache 16.

At 308, archiver retriever 10 searches for the requested object or objects in image store 26. In some embodiments, threads from thread pool 14 are used to search for each requested object.

At 310, archiver retriever 10 retrieves the requested objects. In some embodiments, archiver retriever 10, when searching for images of a particular study, retrieves all images from that study. In some embodiments, this is done in anticipation of a subsequent, but not yet received, request from client 24 the remaining images of the study.

At 312, archiver retriever 10 places the retrieved objects into cache 16. In some embodiments where archiver retriever 10 downloads all of the images of the study, even if a request has not yet made for them, the retrieved but not yet requested items are placed into cache 16.

At 314, the future is notified that the requested object is ready. In some embodiments, if the future had blocked a thread that requested the object, then the future unblocks the requesting thread.

At 316, archiver retriever 10 provides the requested object to client 20. In some embodiments, this involves a service thread accessing the requested object that corresponds to the future in queue 12 and writing it to a network socket. The service thread can be any appropriate thread from any appropriate thread pool. In some embodiments, the thread may attempt to access the object from the future before the object has been downloaded and stored in the future. In such a situation, the future in queue 12 blocks the thread attempting to access the requested object. Once the requested object is written to the future in queue 12, the future unblocks the requesting thread. The thread then sends the requested object to client 20.

As mentioned above, in some embodiments, archiver retriever 10 retrieves all of the images of the study from image store 26 and stores the not yet requested images in cache 16. In some such embodiments, when a request is received for an object that has been retrieved and stored in cache 16, archiver retriever 10 responds to the request by writing the object from cache 16 to the future on queue 12 corresponding to the requested object.

Unordered Request

In various embodiments, archiver retriever 10 supports unordered requests for objects. An unordered request can include, for example, but is not limited, to a request for all the images of a study where the request does not specify the order of images to be delivered.

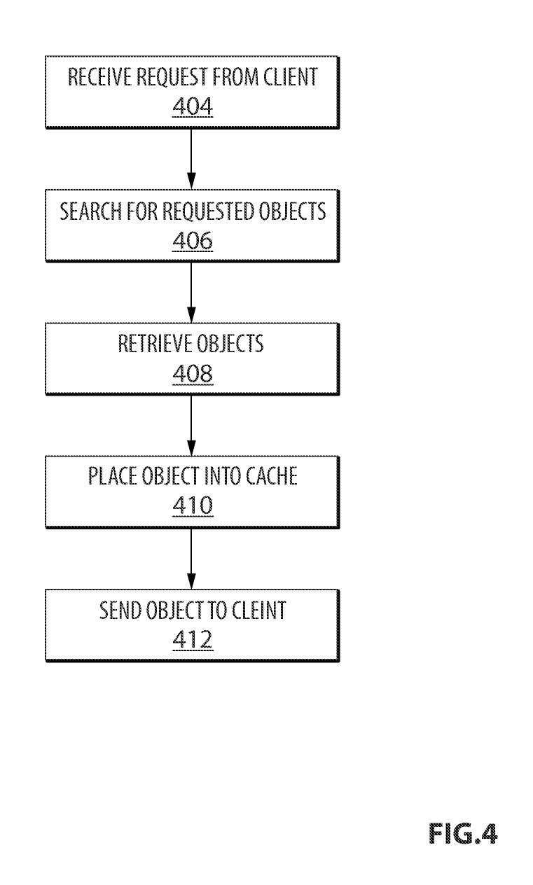

Reference is now made to FIG. 4, which illustrates a flowchart diagram of the process by which archiver retriever system 10 responds to unordered requests for objects.

At 404, archiver retriever 10 receives an unordered request for one or more objects from client 20. The request may be, for example, but is not limited to, an unordered request for all the images of a particular study or an unordered request for a set of images from the particular study.

In some embodiments, archiver retriever 10 determines if a requested object is already stored in cache 16. If the requested object is already present in cache 16, then in some embodiments archiver retriever 10 does not execute 406 to 410 and executes 412 after receiving the request and determining that the requested object is already stored in cache 16.

In some embodiments, archiver retriever 10 does not make use of queue 12 for unordered requests. In other embodiments, archiver retriever 10 populates queue 12 for the request. This can be done similar to 306 discussed above in relation to FIG. 3.

At 406, archiver retriever 10 searches for the requested objects in image store 26. In some embodiments, threads from thread pool 14 are used to search for the requested objects.

At 408, archiver retriever 10 retrieves the requested objects.

At 410, the retrieved objects are placed in cache 16. It should be understood that, in various embodiments, objects are retrieved and stored in cache 16 individually. Accordingly, it is not necessary to read all the objects from image store 26 and store them at the same time cache 16.

At 412, archiver retriever 10 provides the requested objects to client 20. In some embodiments, this involves a thread from thread pool 14 accessing the requested object from cache 16 and writing it to a network socket. In various embodiments, archiver retriever 10 provides the requested objects to client 20 as they become available. Accordingly, in such embodiments, archiver retriever 10 does not wait for all the image files to be retrieved before providing them to client 20. Accordingly, in various embodiments 406, 408, and 410 can operate, at least partially, in parallel.

Redundant Requests

In various embodiments, archiver retriever system 10 is able to handle multiple redundant requests for image data in an efficient manner. The term redundant requests as used herein, denotes requests for the same image data. In various embodiments, archiver retriever system 10 handles redundant requests by only serving one set of requests. Accordingly, in such embodiments, there is only one retrieval.

Redundant request may occur, when the plurality of clients 20 request same image data. This may occur, for example, in a situation where there is a meeting of a plurality of individuals in a conference room. Each individual, may have a computing device, such as for example, but not limited to, a tablet computing device or a laptop, that functions as a client 20. Each client 20 may be coupled to archiver retriever 10 by a network such as a wireless network. If the individuals in the room discuss the same patient or study, then more than 1 of the individuals may attempt to access the same study on their respective clients 20. In such a situation, image archiver 10 would receive requests for the same image data. If image archiver 10 where to service each request individually by retrieving the requested data from image store 26 each time it is requested, the overall performance would suffer and all the users would likely notice a significant delay.

Accordingly, in some embodiments, in a situation where a plurality of requests are received by image archiver 10, image archiver 10 performs only one retrieval operation for a particular object regardless of the number of requests received for that object.

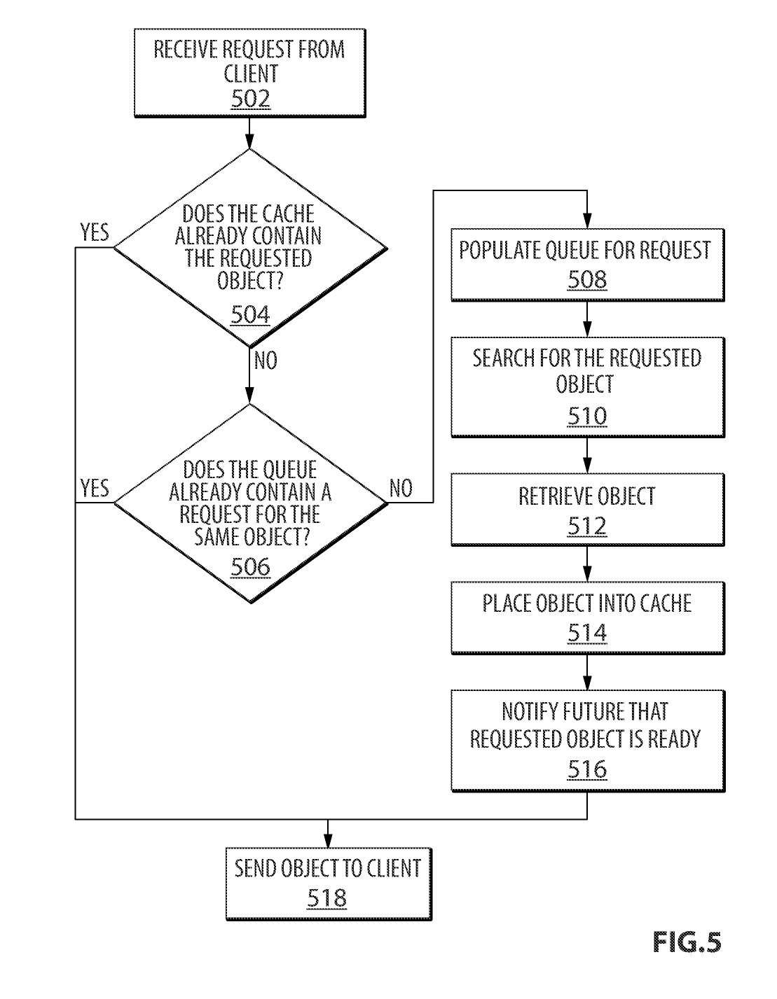

Reference is now made to FIG. 5, which is a flowchart diagram illustrating the process by which archiver retriever system 10 responds to redundant requests for objects from client 20.

At 502, archiver retriever 10 receives a request for an object or multiple ordered requests for multiple objects. The request can be either an ordered request or an unordered request.

At 504, archiver retriever 10 determines whether determines if a requested object is already stored in cache 16. If the requested object is already present in cache 16, then in some embodiments archiver retriever 10 executes 516. On the other hand, if the requested item is not already stored in cache 16 then archiver retriever executes 506.

At 506, archiver retriever 10 determines whether queue 12 already contains a request for the same object. For example, in some embodiments a future is written to queue 12 for each requested object and archiver retriever 10 determines whether a future for the object is already present in queue 12. In some embodiments, only one future is written to the queue for any requested object. In such embodiments, archiver retriever 10 identifies subsequent redundant requests as already in the queue managed by a future and hence does not create another future for the same object. In addition, in various embodiments, once the object is retrieved and the future is released, all requested client threads will be unblocked at the same time.

If archiver retriever 10 determines that queue 12 does not already contain a request for the object, archiver retriever 10 proceeds to 508. On the other hand, if queue 12 already contains a request for the same object, then archiver retriever 10 proceeds directly to 516.

At 508, archiver retriever 10 populates queue 12 for the request. In various embodiments, queue 12 can be populated as described above in relation to FIGS. 3 and 4.

At 510, archiver retriever 10 searches for the requested object in image store 26. In some embodiments, threads from thread pool 14 are used to search for the requested objects.

At 512, archiver retriever 10 retrieves the requested object.

At 514, archiver retriever 10 places the retrieved object into cache 16. In some embodiments where archiver retriever 10 downloads all of the images of the study, even if a request has not yet made for them, the retrieved but not yet requested items are placed into cache 16.

At 516, the future is notified that the requested object is ready. In some embodiments, if the future had blocked a thread that requested the object, then the future unblocks the requesting thread.

At 518, archiver retriever 10 sends the requested object to client 20. If the requested object is not yet available, then the future in queue 12 blocks the request until the object becomes available as described above. In some embodiments, all threads waiting on the same future will be unblocked at the same time or substantially the same time and can retrieve the object in cache concurrently.

Accordingly, in various embodiments, archiver retriever 10 responds to redundant requests by searching for and retrieving a particular object only once from image store 26 and storing that object in cache 16. When additional requests are received for the same object, archiver retriever 10 does not search for and retrieve the requested object from image store 26 again. Rather, in various embodiments, archiver retriever 10 responds to the redundant requests by first determining whether cache 16 already stores the requested object. If it does, then archiver retriever 10 sends the requested object from cache 16 to client 20. If cache 16 does not contain the requested object, archiver retriever 10 determines if a future corresponding to the requested object exists in queue 12. If it does, then archiver retriever 10 waits until the requested item becomes available and does not search for and download it a second time. In other words, in some embodiments, the first request causes a future to be created in the queue 12. The second request will find that the future already exists and so a new one will not be created and the second request will wait on the same future as the first request. When the object is eventually retrieved to cache 16, the future will be notified. The future then unblocks all the threads that are waiting on it. The threads then retrieve the object from cache 16.

Archiver retriever system 10 can use this method to handle redundant requests regardless of whether they are ordered requests or unordered requests. Accordingly, in various embodiments, archiver retriever system 10 utilizes the blocking queue for 2 functions (1) ordered requests; and (2) redundant requests (regardless of whether the redundant request is an ordered request or an unordered request).

In various embodiments, the requested objects are then displayed on the display of one or more clients 20.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method of retrieving objects stored on a storage medium, the method comprising:
receiving a request from a first client for a first object;
populating a queue with the request for the first object;
retrieving the first object from the storage medium; and
sending the object to the first client.

2. The method of claim 1, wherein the request comprises an unordered request for a plurality of images of the study and wherein each image of the study is provided to the first client as it is retrieved.

3. The method of claim 1, wherein the object belongs to a set of objects, the method further comprising:
receiving the set of objects from an object source;
selecting storage parameters for the set of objects, the storage parameters being selected to optimize retrieval time of the objects, the storage parameters comprising a maximum size of an archive file and a number of objects per archive file; and
storing the objects on the storage medium according to the determined storage parameters.

4. The method of claim 3, further comprising:
prior to receiving a request for a second object, retrieving the second object from the storage medium; and
storing the second object in a cache.

5. The method of claim 4, further comprising:
receiving a request for the second object from the first client; and
providing the second object to the first client.

6. The method of claim 1, wherein populating the queue with the request comprises writing a future to the queue, the future corresponding to the requested object.

7. The method of claim 6, further comprising:
writing the first object to a cache; and
notifying the future that the first object has been retrieved.

8. The method of claim 7, further comprising:
blocking an attempt to access the first object from the future if the attempt is made prior to notifying the future that the first object has been retrieved.

9. The method of claim 8, further comprising:
subsequent to the first object being written to the future on the queue, unblocking the attempt to access the first object.

10. The method of claim 7, further comprising:
receiving a second request for the first object from a second client;
populating the queue with the second request for the first object;
determining that the queue contains a first request for the first object; and
providing the requested object to the second client from the cache.

11. A non-transitory machine-readable memory storing statements and instructions for execution by a processor to perform a method of:
receiving a request from a first client for a first object;
populating a queue with the request for the first object;
retrieving the first object from a storage medium; and
sending the object to the first client.

12. A system for archiving and retrieving files, the system comprising:
a queue;
a thread pool;
a cache; and
a processor, the processor configured to:
receive a request from a first client for a first object;
populate the queue with the request for the first object;
retrieve the first object from a storage medium; and
send the object to the first client.

13. The system of claim 12, wherein the request comprises an unordered request for a plurality of images of the study and wherein the processor is further configured to provide each image of the study to the first client as each image is retrieved.

14. The system of claim 12, wherein the object belongs to a set of objects, the processor being further configured to:
receive the set of objects from an object source;
select storage parameters for the set of objects, the storage parameters being selected to optimize retrieval time of the objects, the storage parameters comprising a maximum size of an archive file and a number of objects per archive file; and
store the objects on the storage medium according to the determined storage parameters.

15. The system of claim 14, wherein the processor is further configured to:
prior to receiving a request for a second object, retrieve the second object from the storage medium; and
store the second object in a cache.

16. The system of claim 15, wherein the processor is further configured to:
receive a request for the second object from the first client; and
send the second object to the first client.

17. The system of claim 12, wherein the processor is further configured to populate the queue with the request by writing a future to the queue, the future corresponding to the requested object.

18. The system of claim 17, wherein the processor is further configured to:
write the first object to a cache; and
notify the future that the first object has been retrieved.

19. The system of claim 18, wherein the processor is further configured to:
block an attempt to access the first object from the future if the attempt is made prior to notifying the future that the first object has been retrieved.

20. The system of claim 18, wherein the processor is further configured to:
receive a second request for the first object from a second client;
populate the queue with the second request for the first object;
determine that the queue contains a first request for the first object; and
provide the requested object to the second client from the cache.
